(19) United States
(12) Patent Application Publication
(10) Pub. No.: US 2026/0243224 A1
(43) Pub. Date: Aug. 20, 2026

(54) Artificial wave energy maker and wave energy harvester hydro power producing reactor process and system

(71) Applicant: Ernest Keith Eberhardt, Farmingville, NY (US)

(72) Inventor: Ernest Keith Eberhardt, Farmingville, NY (US)

(21) Appl. No.: 18/831,666

(22) Filed: Jul. 14, 2025

Related U.S. Application Data
(60) Provisional application No. 63/834,070, filed on Feb. 18, 2025.

(51) Int. Cl. F03B 13/14

(52) U.S. Cl. CPC F03B 13/14; F05B 2220/705; F05B 2220/708

(57) ABSTRACT

An example of a Hydrokinetic energy process and system that comprises a suitable size body of water, giving the body of water sufficient depth and breadth. A distribution of wave energy converting devices placed in, on or around that body of water and one or more of wave energy making devices located in, on or around the body of water. The wave energy converting devices are arranged to be activated upon receiving a flow of man-made waves from the wave energy making devices. The action of the wave energy making devices causes a wave amplitude of sufficient size to activate the wave energy converting devices to produce electricity. The wave energy converting devices are affected to move a sufficient distance to achieve a useful outcome, such as powering the wave energy making devices, as well as supplying electricity to the grid simultaneously, for example. This system is devised to supply electricity to the grid and/or in a more local and self-sufficient manner.

### BACKGROUND OF THE INVENTION

Renewable hydrokinetic power generation and energy storage technologies are continuously evolving to accommodate our ever increasing demand for electricity. The known hydrokinetic power producers rely on natures inability to move water consistently. The inconsistency is due to varying rates of precipitation that affect reservoir levels, river flow speed and the sea conditions that are affected by the sun, moon, wind and earthly tectonics. The hydropower industries mind set in using nature made water conditions, as an energy source, is that it considers it to be free energy.

The known methods of extracting this hydrokinetic energy are hydropower dams with reservoirs that use turbines, various types of marine hydrokinetic energy devices, that use several types of floating bobbing buoy style generators, run of the river or ocean tide current that uses rotating blades attached to a shaft and pumped storage. All of these methods have location requirement limitations due to the environmental whim and the will of Mother Nature, Mother Earth and Father Time's ability to provide sustainable amounts of hydrokinetic energy. There are power buoys that generate electricity to run lighting on the exterior of the buoy and to charge a backup battery. Any lengthy amount of time with calm seas results in no waves, no power, no lights. There are pumped storage facilities that act like a hydropower battery by recycling the spent water energy that travels from an upper reservoir to a lower reservoir and back up again via the use of pumps. The upper reservoir has a limited volume of water to supply energy to the turbines. Combining pumped storage with solar, wind and battery technologies can produce electricity self-sufficiently, but only part-time. A requirement of a substantial height difference in the upper and lower reservoirs makes finding suitable locations challenging and somewhat more expensive. Solar, wind and battery power systems also have their limitations due to their unpredictable energy sources and the battery life is like an Achilles heel.

There are small man-made wave pool machines that manufacture waves for testing purposes. Scaled down versions of wave energy conversion devices are tested in these small wave pools. Sometimes there is testing for electrical output of these devices. The wave making machines are powered by an external electric source like the grid for example and are not part of a self-powering system. They don't directly use solar, wind or battery technology to run the wave making devices as part of a system. The wave making machines use more electricity than the wave energy converter produces during the test. Wave pool testing facilities have never been used with the intention of supplying electricity to the Grid from the pool. The electricity produced in the wave pool is not from what the industry or those of ordinary skill in the art would consider to be free energy because they are using electricity from the grid to make the waves. Although this is an extremely obscure method for producing tiny amounts of electricity with man-made machine wave energy it deserves to be mentioned in the Background because it exists and may be considered as prior art due to some partial similarities. All and any wave pool testing is geared towards how the devices tested will eventually work in an ocean environment that involves harsh corrosive conditions and unpredictable, naturally occurring waves.

There are hundreds, maybe thousands of videos and articles written about marine wave energy that publicize its great potential. Every one of them is talking about using free ocean wave energy to power their wave energy converting devices, with the intention of supplying electricity to a grid, while knowing all along that source of power can be somewhat as inconsistent as solar and wind power at times. The names of some of the companies that design and build wave energy converting devices are OPT from NJ, Oscilla from WA, and C-Power from VA/OR. To my knowledge there aren't any public acknowledgements, to be found anywhere, that discuss the use of man-made waves as a viable source of useful energy that can power wave energy converters to make utility/grid size electricity while also powering the very wave energy making devices that supply the very energy required to activate the wave energy converter devices. Operators of and anyone who has ever been associated with wave pool testing facilities continue to be unaware of the unheard of unlimited energy potential there is in man-made machine manufactured waves. The names of some of the companies that design and build wave/surf pools are American Wave Machines from CA, Wave Prizm from NC and Kelly Slater from CO.

The present disclosure is directed to power systems that provide significant advantages and capabilities over prior art power systems of the type discussed above.

### SUMMARY OF THE INVENTION

The present disclosure provides systems, methods and apparatus that enable generating, storing, and/or transferring power efficiently by way of harnessing the hydrokinetic energy from man-made waves that can be produced in land based reservoirs, and other fresh water and marine environments and can be, in some of the optional applications, done in a self-sufficient manner. This new method majorly improves on and reduces the location limitations, that exist in current nature oriented Hydropower/Hydrokinetic energy producing systems.

Up until now, with 7 billion people in the world, no one has thought of using wave energy that was not produced by nature to generate utility/grid size amounts of electricity. There are 10's of thousands of people involved in the Hydropower/Hydrokinetic energy industry who are skilled in the art of understanding this new radical approach, but will not become aware publically of doing it until they learn of it from being enlightened by my invention. The present disclosure that provides this process and system that uses machine manufactured waves has become, to some degree, a source of man-made free energy. The devised result of this involuntary symbiotic mechanical/electrical relationship is the creation of a process that produces a way to recycle energy. This process and system may be the “Holy Grail” of the energy producing technologies

The many previously unknown advancements of the present disclosure over prior art clearly distinguishes it from any similarities to wave pool testing methods. Some of the distinctions are:
1.The wave pool uses the grid to power it. The new method can, but has many alternative sources and options outside the grid to choose from to power it.
2. The wave pool uses more electricity than it produces. The new method generates electricity in excess to what it takes to run the system.
3. The wave pool does not supply electricity to the grid, only to monitoring devices. The new method is capable of supplying almost all the electricity the world will ever need.
4.The wave pool is not self-powering. The new method has several options to choose from that make it self-powering.
5. The wave pool is used to test ocean going electricity producing technologies that rely on waves made by nature. The new method can operate in a salt water environment but it does not need to because it makes its own waves.
6. The users of wave pool testing facilities are completely unaware of how much potential there is in man-made wave systems. I, alone, am aware that the new method has more potential to generate more electricity cleanly, than any other means because like all others it doesn't rely on any external fuel/energy source to power it, unless you take evaporation into consideration, which may cause the need for water to be added from time to time.
7. The wave pool doesn't use solar, wind and battery power to run the wave maker unless It's through the grid. The new method can use solar, wind and battery power to start and/or run itself as one of the options.

The following are some examples of combinations of optional sources that can start the system wave energy making process running and/or keep it running:
1. A Self-sufficient hydrokinetic power system, the present disclosure, starts it and runs it.
2. A solar, wind and battery power system starts it and a hydro kinetic system runs it.
3. A solar, wind and battery power charging system starts it and the battery runs it.
4. A grid power starts it and a hydrokinetic power system runs it.
5. A grid power starts it and runs it.
6. A hydropower dam system starts it and a hydrokinetic power system runs it.
7. A hydropower dam system starts it and runs it.
8. A fossil fuel power generating system starts it and a hydrokinetic power system runs it.
9. A fossil fuel power generating system starts it and runs it.

To those who are skilled in the art, it shouldn't take very long for them to realize how imme-nsely valuable the commercialization of this improvement and/or invention will be. There will more than likely be the need to employ the use of other prior art patented technologies, like wave making machines as well as wave energy converting devices and battery powered starter devices and charging devices, for example, in order to bring the present disclosure to commercial fruition. As far as needing to use several different types of prior art to make this invention useful and cost effective in relation to existing energy technologies, such as fossil fuel, nuclear and other various renewables, there will have to be a meeting of the minds. There will not only be competition between the companies that manufacture the prior art technologies but also they will be competing against all the other existing energy producing technologies. Competition is the great equalizer. A determination will be made as to which of the prior art technology wave energy makers and wave energy converters is best suited for implementation by the users. The users will be Utility companies that produce their own electricity as well as buy it from other energy producers.

I imagine there may be great financial gain incentive as a temptation for some of the owners of these patented technologies to attempt to try to find a legal way to infringe on and skirt around my future patent rights by trying to deal with my potential licensing customers directly after learning of this technology. At the same time there may also be a temptation for anyone with enough money or backing, including utility companies to try to infringe by using an existing or construct a new reservoir, almost anywhere and have this new system installed by approaching and working in conjunction with the owners of the patented technologies.

Additional features and advantages of the disclosed systems apparatus and methods are described in, and will be apparent from the following Detailed Description and the Figures. The features and advantages described herein are not all-inclusive and, in particular, many additional features and advantages will be apparent to one of ordinary skill in the art of view of the figures and description. Also, any particular embodiment does not have to have all of the advantages listed herein. Moreover, it should be noted that the language used in the specification has been principally selected for readability and instructional purposes, and not to limit the scope of the inventive subject matter.

### BRIEF DESCRIPTION OF THE INVENTION AND DRAWINGS

Parts of the Embodiment Numbered List and Figures of the Drawings Numbered List.

### PARTS OF THE EMBODIMENT NUMBERED LIST

1 Hydro power reactor system
2 Body of water-Existing or new reservoir, lake, river, salt water bay or ocean water area.
3 Wave energy making devices.
4 Wave energy harvesting and electricity generating devices.
5 Expandable array area.
6 Reservoir shoreline or wall.
7 Hydro power electric producing dam. (optional)
8 River inflow. (optional)
9 River outflow. (optional)
10 Waves Energy.
11 Battery.
12 Battery charger.
13 Starter generator device for wave energy making device.
14 Waves energy channeling devices.
15 Overtopping wave disbursing wave energy converting devices.
16 Wave water return trough.
17 Wave energy converting device anchoring cable.
18 Water conservation cavity recess for anchoring cable and wave energy converter device appendage.
19 Reservoir bottom.
20 Reservoir water level median.
21 Water waves energy flow direction lines.
22 Overtopping wave disbursing device or beach.
23 Water waves energy return flow direction lines.

### FIGURES OF THE DRAWINGS NUMBERED LIST

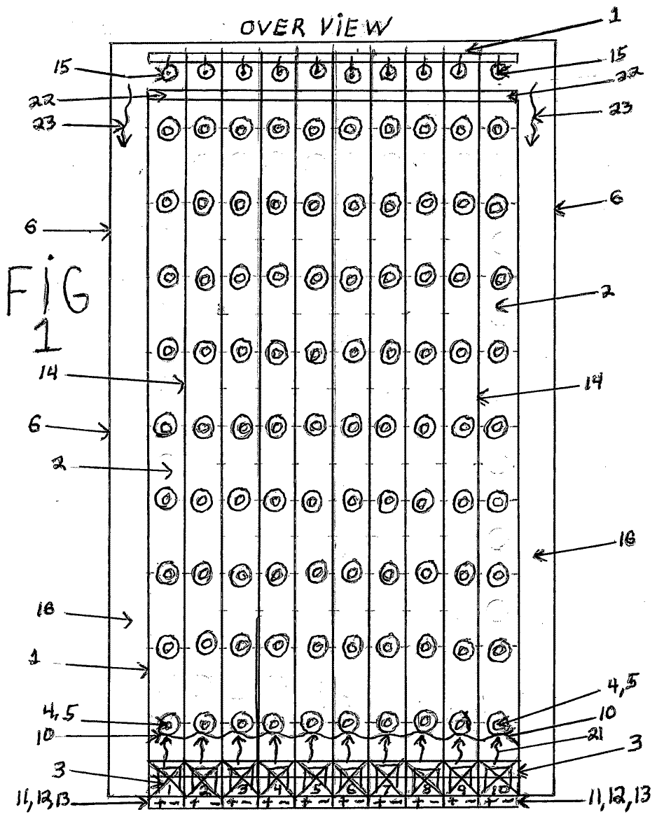

FIG. 1—Shows a Best Mode Drawing of the entire system 1, which includes all of the numbered Parts of the Embodiment List.

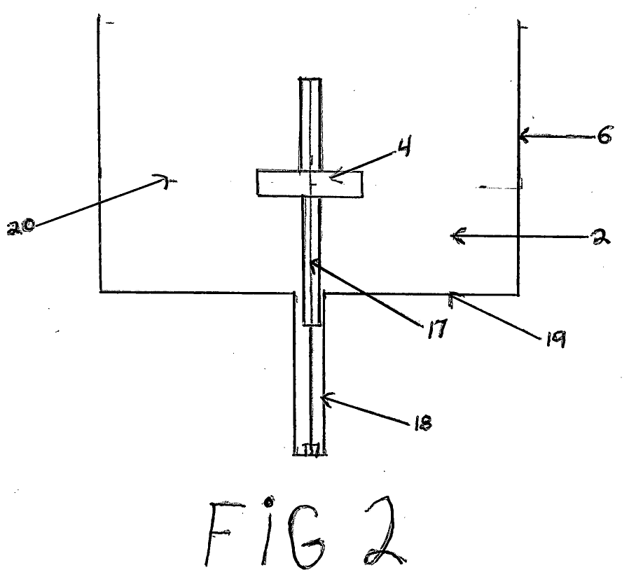

FIG. 2—Shows a side view elevation of a wave energy converter device 4 at rest, with a lower appendage and anchoring cable 18 that are recessed into a water conservation cavity 18 set inside a walled body of water 2.

FIG. 3—Shows an elevation of a first line array of wave energy converter devices 4 at rest, that are running parallel to the line of wave energy making devices 3, that are not drawn in the figure, with the wave water flow return trough 16 that runs parallel to the waves energy channeling devices 14.

FIG. 4—Shows an overhead view of a wave energy maker device 3, that is also shown in FIG. 1.

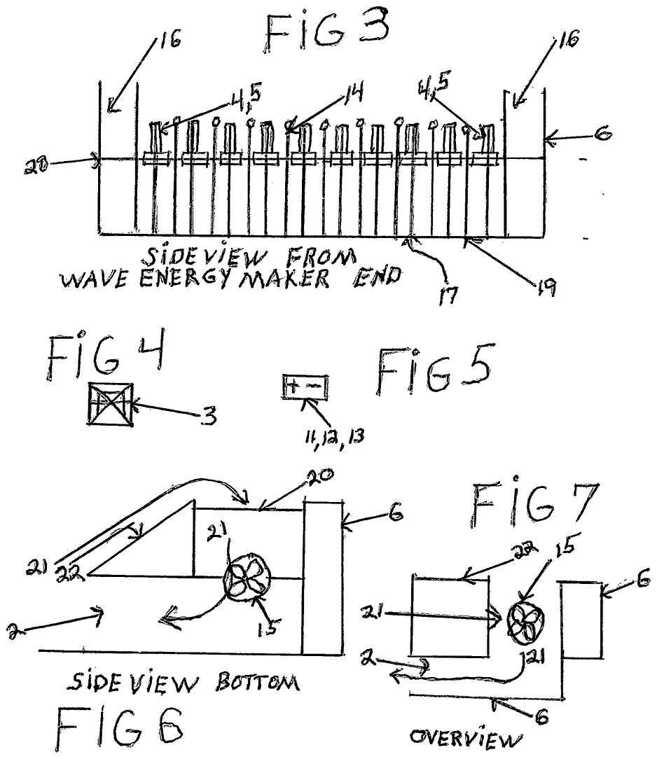

FIG. 5—Shows a battery 11, battery charger 12 and the starter generator devices for starting the wave energy making devices.

FIG. 6—Shows a side view of an overtopping wave energy disbursing device or beach 22, with a wave energy converting device 15, with water wave energy flow direction lines 21, within a walled 6, body of water 2, with a reservoir water level median.

FIG. 7—Shows an overhead view of FIG. 6.

### BRIEF DESCRIPTION OF THE INVENTION DRAWINGS

Understanding the Parts of the Embodiment List and their referenced numbers below and how they relate to running the process and system:
1 The Hydro Power Energy Reactor Process and System 1 is comprised of a body of water 2, wave energy making devices 3, and wave energy harvesting devices 4, waves energy 10, a battery 11, a battery charger 12, a wave energy making device starter device 13, wave energy channeling devices 14, overtopping wave disbursing wave energy converter devices 15, wave water return troughs 16, wave energy converter device anchor cable 17, water conservation cavity recess for anchor cable and wave energy converter device appendage 18, reservoir bottom 19, reservoir water level median 20, water wave energy flow direction lines 21, overtopping wave disbursing device or beach 22, water wave energy return flow direction lines 23, all for the purpose of generating electricity.
2 A body of water 2 supplies water to the system 1.
3 A wave energy making device-starter device 13, draws power from a battery 11, to cold start the wave energy making devices 3 when called upon.
4 Wave energy making devices 3, are located in the body of water 2, and are activated by the starter device 13, to make waves energy 10.
5 Wave energy harvesting devices 4, are located in the same body of water 2 as the wave energy making devices 3 are in, in an expandable array 5, in a manner in which they can be optimally positioned to be activated by waves energy 10 made from wave energy making devices 3, to generate electricity.
6 In an attempt to maximize the systems 1 efficiency, walled wave channeling devices 14 can be placed in the body of water 2. Once the waves energy 10 are created they will flow immediately into these wave channeling devices 14 and will allow the waves energy 10 to focus directly on the wave energy harvesting/converting devices 4. There will be a minimal amount of wasted waves energy 10.

The wave energy harvesting/converting devices 4 will be placed and optimally spaced in a row within the confines of the wave channel devices 14 in a perpendicular manner to the wave energy making devices 3.
7 Electricity made by the wave energy harvesting devices 4, powers the wave making devices 3, powers the battery charger 12, and produces excess electricity for use in places like the grid or local communities, for example, simultaneously and self-sufficiently.
8 The starting device 13, will power the wave energy making device 3, until the wave energy harvesting devices 4, achieves producing a sufficient amount of electricity to power the wave energy making devices 3, without the need of the starter device 13 then the starter device 13 disconnects until needed again.
9 The waves will proceed to the opposite end of the system reservoir 1 where they will encounter the overtopping wave disbursing wave energy converter device 15 where the waves energy 10 is slowed down and collected to be processed by a wave energy converter device 4 and discharged into the wave water return trough 16 to recycle and resupply water to the wave energy making devices.
10 The system 1 will continue to run indefinitely while creating energy that creates electricity to create more energy to create more electricity, until it is turned off, breaks, or is in need of maintenance or repair.

### How the Process and System Works:

1 In one scenario, which happens to be represented by Drawing #1 Best Mode of the Process and System 1, where all amounts and figures are approximate. Drawing 1 shows 10 wave energy making devices 3, each having their own starter generator device 11, 12, 13. This method allows for all 10 of the wave energy making devices 3 to engage at the same time if preferred. The following scenario is optional and is used to explain how the process can begin by engaging each of the 10 wave energy maker devices 3, one at a time in succession. A battery powered starter/generator device 11, 12, 13 starts the wave energy maker device to begin to make waves energy 10. The wave energy maker device 3 creates wave #1 that is 8 feet high by 20 feet wide. The amount of electric needed to make the wave could be 2 MW. The wave immediately enters the channeling device 14 and encounters a first wave energy converter device 1, in 1 second. This wave energy converter device 1, generates 1 MW from each passing wave. There are prior art wave energy converters that can produce more than 1 MW of electricity. It is unknown to me how far a man-made wave can travel while maintaining a usable amount of energy. The evidence shown from surf park videos appears to create waves that can travel several hundred yards or more, while maintaining shape and energy integrity, which would be a sufficient distance to actuate a line of 10 wave energy converter devices. The first wave 10 continues on to encounter wave energy converter devices #2, #3, #4, #5, #6, #7, #8, #9, and #10 using the original energy that is stored in the mobile energy wave from its creation by the waves energy maker device 3. The starter/generator device 11, 12, 13 is still supplying power to keep the system 1 running but now with additional electricity being generated by each of the wave energy converter devices 4 in succession.
2 The wave energy maker device creates wave #2 while wave #1 is encountering wave energy converter device #1. The wave maker device is creating wave #3 while wave #2 is encountering wave energy converter #1 and wave #1 is encountering wave energy converter device #2.
3 The wave energy maker device creates wave #4 while wave #3 is encountering wave energy converter device #1, while wave #2 is encountering wave energy converter device #2, while wave #1 is encountering wave energy converter device #3.
4 As the process continues, by following the sequence above, it can be projected that when wave #10 is created the system will have used 20 MW of electricity in order to produce 55 MW, netting an excess of 35 MW of electricity. All of the waves will use 2 MW to be created but will generate 10 MW, after flowing through all 10 of the wave energy converting devices 4, in its corresponding wave channeling device, which will net 8 MW of excess electricity per wave.
5 When the system starts it appears that all the waves created, up to and including #6 will have used 12 MW to do so. The system will have produced 15 MW at this point. So because the system will continue to produce more electricity than it takes to run it, at this point, the starter/generator will disengage and the system will run itself, while generating an abundance of excess electricity. A projection chart is included in the Drawings on page 4.
6 The system can be expanded by adding more of the same wave energy making devices that can power more of the same wave energy converting devices in the same manner that has been described previously. The energy created by this hydrokinetic closed loop system Reactor and how it explodes and expands is similar to a nuclear reaction but without using any fuel.

### DETAILED DESCRIPTION OF THE INVENTION

Outline covering the requirements by the numbered paragraphs-
1. What the Invention is—[0012], [0013], [0014].
2. Process of making and using, Best way-[0012], [0013], [0014], [0017], [0020].
3. Distinguishes it from the old-[0012], [0013], [0014], [0016], [0017], [0018], [0019].
4. Improvements specific to the Invention-[0014], [0015], [0016], [0018], [0019], [0021], [0022], [0023], [0024].
5. Understand the parts and all parts should be in it-this is in the Brief Description of the Invention, which should be considered as part of the Detailed Description of the Invention.

### DETAILED DESCRIPTION OF THE INVENTION

The Invention that is provided can be described as a self-sufficient “Hydro Power Energy Reactor”. This is a new original process and system that generally improves on generating energy and electricity in the hydropower/hydrokinetic field and in particular the usefulness of converting the energy created by man-made waves into an abundance of excess electricity. The system is comprised of 5 basic parts, a body of water, a distribution of wave energy making devices placed in, on or around that body of water, a distribution of wave energy harvesting/converting devices placed in, on or around that body of water, a distribution of waves energy channeling devices for the purpose of maximizing the efficiency of harvesting the waves energy and a system-charging battery operated starter generator mechanism.

Understanding the parts and how the process and system works involves referencing the numbered Figures below to the Brief Description of the Drawings, the parts of the embodiment list and the drawings, as the drawings apply firstly to a Best Mode, which is a newly constructed body of water style reservoir:
The Hydro Power Energy Process and System FIG. 1 of the drawings, is comprised of a body of water 2, wave energy making devices 3, and wave energy harvesting/converting devices 4, wave energy converter device array 5, reservoir shoreline and/or wall 6, waves energy 10, a battery 11, a battery charger 12, a wave energy making device starter device 13, wave energy
channeling device 14, overtopping wave disbursing wave energy converting device 15, wave water return trough 16, wave energy converter device anchoring to bottom cable 17, water conservation cavity recess for anchoring cable and wave energy converter device appendage 18, reservoir bottom 19, reservoir water level median 20, water wave energy flow direction lines 21, overtopping wave dispersing devices or beach 22, water wave energy return flow direction lines 23, all for the purpose of generating electricity. Numbers 7,8 and 9 on the parts of the embodiment list are not needed in the Best Mode application. They would apply in the case of an existing reservoir installation.

The system can produce abundant electricity without the involvement of any of the following energy sources: fossil fuel, solar power, wind power, nuclear and traditional hydropower methods, to mention some of the major examples, as part of the process. Although it is not necessary to employ any of the energy sources listed above as part of the process, this new system can work in conjunction with all of them if preferred and if it becomes advantageous to do so.

There are many prior art types of wave energy making devices that can be used in this process. For example: plows, paddles, levers, plungers, textile and pneumatic. There are many prior art types of water wave energy harvesting devices that can be used in this process. For example: point absorber, attenuator, oscillating wave surge converter, oscillating water column, overtopping/terminator device, submerged pressure differential, bulge wave and rotating mass. There are prior art types of battery powered starter generating devices that can be used in this process. Placing both the wave energy making and wave energy harvesting technologies in close proximity to one another, in a body of water like setting, such as an existing reservoir or those specifically designed and newly constructed to accommodate this process, in a new fresh or salt water reservoir or lake or river or appropriate bay or ocean environment will create the potential to produce an abundant supply of electricity.

All of the above mentioned prior art technologies and their purposes that have clearly been explained in this description, will either make waves energy or generate electricity. As to which one is the least expensive to build, per Megawatt produced,“ best mode”, will be determined through competition between the different companies that make the devices and their methods of operation and the actual users who purchase the system as time goes on. In the case of implementing the system into existing reservoirs etc., some consideration will be needed into how best to adapt the system to that environment. The best mode for the system is to be installed in a newly constructed body of water that creates an environment for maximum efficiency. My application is not necessarily concerned with the best mode in respect to the abilities of each individual prior art, although my research has shown that there is a point absorber style wave energy converter device that is capable of producing 1 Mw of electricity and a company named Wave Prizm has a wave energy making device that is one of the most efficient. The improvement/invention has to do with the unheard of method of a system that uses man-made waves to generate excess electricity in a self-sufficient manner and all the additional previously unknown benefits thereof that have been mentioned in this description.

Making man-made machine waves and harvesting their energy in a self-sufficient manner to generate utility/grid size electricity or as a more local independent alternative, is a novel approach in the field of energy production. The flow of these artificial waves can be large enough and can travel long enough distances to provide repetitive, predictable, self-sufficient energy in the form of consistently spaced wave energy currents that can be converted to electricity by the wave energy converting devices. The electricity, when sufficiently produced by the wave energy converting device or devices can power the wave energy making device or devices to make the waves that supply the energy to activate the wave energy converting devices, as well as simultaneously generating large, grid size useful amounts of excess electricity during the process, making the system virtually self-sufficient, useful and unheard of. The devised result of this involuntary symbiotic mechanical/electrical, reciprocating relationship is the creation of an excessive supply of independently made, carbon free, environmentally beneficial, wildlife beneficial, safe, clean, cost effective, renewable and recyclable energy induced electricity.

Current wave making technology shows a man-made water wave energy making device can control the size and the frequency of the waves created. This attribute will give needed flexibility to adjust how much energy is produced to satisfy the variable loads placed on the “Hydro Power Energy Reactor” by electricity demand. The current prior art, utility grade wave energy harvesting technology relies on “Mother Natures” limited, unpredictable, uncontrollable, occasional generosity to supply the wave energy to generate the force necessary to activate the wave harvesting devices used. This energy source is only found on the coastline or offshore of naturally occurring bodies of water.

The current wave pool technology which doesn't supply electricity to the grid, but draws energy from the grid, is being used for recreational and environmental, marine and commercial product experimentation testing purposes. By improving on the old use, this new, improved process and system allows the waves energy created by the wave energy making devices to supply a force to activate the wave energy harvesting/converting devices to generate utility scale electricity as well as power itself, within a more controlled and predictable environment.

A battery, that is charged by a charger that is powered by the system, supplies power to a starter generator, that runs temporarily to start the wave energy making devices, to supply a force to activate the wave energy harvesting/converting devices until the wave energy harvesting/converting devices kick in to fully power the system.

In times of drought or normal seasonally low precipitation amounts, existing reservoirs that have hydropower dams in place and are fed by a river, for example, will have their power output negatively affected when water levels drop. By installing this system in the reservoir, they will have an additional constant energy source to run full time independent of the dam or supplement the dams output when needed and without detracting from the volume of water in the reservoir.

Existing hydropower technology is severely limited by geography. All of them need to be located on naturally occurring or man-made gravity induced waterway sources. An additional requirement to the most productive types, dams and pumped storage, for example, is that they need to have substantial height differences in order to produce electricity effectively. New free standing “Hydro power Energy Reactor” oriented reservoirs, could be multi-tiered, but do not need more than one level, can be built practically anywhere there is access to surface or ground water or water transported by truck or pipeline. They can be built underground or under the surface of the water in a bubble environment, for example.

The system can be constructed in a body of water with water volume conservation in mind, by creating the shallowest adequate water setting necessary. Installing the wave energy converter devices lower appendages, shafts, anchors and cables, etc. into smaller diameter cavities that are recessed into a position that is below the bottom of the reservoir would be a solution. These cavities would drastically reduce excavation requirements and expense, as well as keep reservoir wall heights to a minimum, in a newly constructed reservoir as well as give flexibility to water depth requirements in existing reservoirs. If a multi-tiered system would be advantageous due to space location issues, the supporting columns could be engineered to house the cavities discussed above.

Since the system is capable of being installed in a fresh water environment, the level of corrosiveness on the devices from salt water would be substantially less, which would add to the life expectancy of the devices used. The mechanisms located in the somewhat better weather protected freshwater environments would not be subjected to the violent open water ocean conditions, which would possibly allow for less expensively designed wave energy harvesting/converting devices.

This system is capable of being installed along side of a river in such a manner that reduces or eliminates the need for damming, which in turn makes the need for fish ladders virtually obsolete and is beneficial for all wildlife migration, reproduction, and habitat that live in and around rivers.

Because the system can be built to supply electricity locally, the need for lengthy transmission lines could be drastically reduced. With this “All power is local” availability, the need for some foreign energy imports like hydropower electricity from Canada would be reduced or eliminated altogether or even reversed. Reducing long transmission lines can lower the chance of wildfires caused by utility company equipment failure. Communities can have their own electric companies which could even eliminate the need for meters. People could use as much electric as they want. The cost of the system and the electric it produces could be paid for through property taxes and zoning.

By having smaller more localized systems, the devastating effects incurred by cyber-attacks on large scale grid systems, could be diminished drastically because of the sheer number of individual, independent communities with their own systems.

What is claimed is:

1. A hydrokinetic process and system comprising:
A system is created by combining 2 separate hydrokinetic processes. Process one consists of one or more water wave energy making devices and process 2 consists of one or more electricity producing water wave energy harvesting/converting devices, both and all of which are located in, on and/or around a body of water that contains a sufficient depth and shape for the system to function, for the unheard of useful purpose of producing energy to generate an abundance of excess electricity, self-sufficiently, without the need of assistance from any external power source or fuel and with minimal to no normal geographic restrictions as to where the system can be installed.

2. The system of claim 1, wherein the wave energy converting devices are activated by the energy from the waves produced by the wave energy making devices.

3. The system of claim 2, wherein the energy from the wave that is produced by the wave energy maker device can actuate any and all of the wave energy converter devices, some simultaneously and some alternately in succession to produce electricity.

4. The system of claim 3, wherein the amount of electricity produced by the combined output of the wave energy converter devices that are activated from the combined energy of all the waves energy, can exceed the electricity the wave energy making devices requires to make those waves, when the system is running optimally.

5. The system of claim 3, wherein the wave maker device is powered by the electricity made by the wave energy converter devices when the system is running optimally.

6. The system of claim 1, will continue to run indefinitely making it virtually self-sufficient until it is turned off, breaks, or is in need of maintenance or repair.

7. The system of claim 1, wherein a battery and/or battery powered generator and battery charging device can be used to cold start the system running. The system can self-charge the battery by using some of the abundant, excess electricity that is being produced by the system while its running.

8. The system of claim 1, wherein a starter, battery and battery charging device as well as the wave maker device, are compatible with and can be powered by sources other than the present disclosure if preferred.
a. The alternative sources can be supplied directly or through the grid and mainly include for example, solar and wind, nuclear, fossil fuel and other hydrokinetic technologies such as hydroelectric dam power, pumped storage and run of river tidal current.

9. The system of claim 1, wherein a body of water that contains this electricity producing self-sufficient system, can be installed and operated practically anywhere.

10. The system of claim 9, wherein the ability for the system to be installed locally and remotely reduces the need for importing electricity over long transmission lines from other more financially and environmentally expensive sources.
a. The sites chosen will be done so with easy access in mind. Reactor like/power plant systems can be built in months, not years because the permitting process should be a breeze due to how environmentally friendly the process is.
b. Reducing long transmission lines in forested areas lowers the chance of utility company equipment failure that has been known to cause forest fires.

11. The system of claim 9, wherein, examples of the flexibility of prospective locations would be:
above ground, below ground, on the water, under the water, in a building, on top of a building, under a building and pretty much anywhere there is a naturally occurring or man-made surface that meets the very adaptable requirements for installation.

12. The system of claim 6, wherein the system can run 24/7 while generating large amounts of electricity that can be predictably controlled by altering the frequency and size of the waves produced by the wave energy making devices and/or limit the amount of wave energy converting devices that are turned on, to meet varying load demands placed on it by power users.

13. The system of claim 11, wherein when installing this system in an existing dammed hydropower producing reservoir, the dams power output will not be affected negatively because the system does not detract from the volume of water in the reservoir.
a. The system can enhance the overall power output of existing hydropower dam reservoirs and can help the dams power output to be maintained at maximum efficiency.

14. The system in claim 9, wherein the system can be located in a calmer fresh water setting instead of a more violently turbulent ocean environment, will result in less wear and tear, and will reduce the corrosive effects of salt water on the devices used, thereby extending substantially the life expectancy of the parts of the system and may allow for the systems devices to be made from less expensive materials.

15. The system in claim 9, wherein the system can be installed next to a river, not necessarily above, which would eliminate the need for damming.
a. The ability of the system in claim 15 would make fish ladders unnecessary and would be environmentally beneficial to all of the local wildlife migration and habitat.

16. The system of claim 4, wherein the amount of electricity the system in claim 1 can produce is directly related to the size of the parts, the efficiency of the devices and the quantity of the devices. The larger the reservoir, the more wave energy maker devices and wave energy converting devices can be deployed, hence the more electricity can be produced.

17. The system in claim 9, wherein the system can be adapted to shallow water settings for wave energy converting devices in regards to the parts or appendages, that extend downwardly, to the bottom, such as anchors, cables and shafts, etc. by creating small diameter cavities that are recessed into the bottom of the reservoir or river for the purpose of installation flexibility and conserving on th e size of the body of water.
